(19) United States
(12) Patent Application Publication
(10) Pub. No.: US 2014/0315184 A1
(43) Pub. Date: Oct. 23, 2014

(54) Combination Magnetic Board and Dry Erase Board

(71) Applicant: Detail Driven, Easton, PA (US)

(72) Inventor: Patricia Jorgenson, Easton, PA (US)

(21) Appl. No.: 13/867,357

(22) Filed: Apr. 22, 2013

(51) Int. Cl. B43L 1/10; B43L 1/04

(52) U.S. Cl. CPC B43L 1/10; B43L 1/045
USPC 434/408

(57) ABSTRACT

A combination magnetic and dry erase board includes a magnetic retaining portion having a planar substrate having properties to attract and retain a magnet thereon and a bleach-resistant covering disposed over the substrate. A dry erase portion includes a porcelain surface. The dry erase portion is adjacent to the magnetic retaining portion. The entire board is bleach resistant and can be used in a hospital or other medical environment such that the board can be disinfected with a bleach product.

### FIELD OF THE INVENTION

The present invention relates to a mounting board having both a magnetic portion for mounting objects using magnets and a dry erase portion to allow messages to be removably written. The entire board is resistant to bleach and is suitable for use in a hospital or other medical environment.

### BACKGROUND OF THE INVENTION

Mounting boards are extensively used to secure or write information on them. Such mounting boards may be magnetic boards that are used to secure papers thereto with magnets, dry erase boards that allow user to write information with a dry erase marker and easily erase it, and cork boards that are used to secure papers thereto with pushpins. It is often convenient and beneficial to have such mounting boards available in a hospital or other medical-type environment, such as, for example, in a patient's room. However, due to the significant numbers of viruses, germs, and harmful bacteria that are prevalent in such an environment, the equipment in these environments is often disinfected, sometimes daily. Bleach-containing disinfectants are often used, due to the inherent ability of bleach to kill most germs, viruses, and bacteria. Such bleach-containing disinfectants, however, also have a deleterious effect on the equipment on which they are used, resulting in a breakdown of the equipment and requiring eventual replacement of the equipment.

It would be beneficial to provide a mounting board that can be used in a medical-type environment that can be frequently cleaned with a bleach-containing disinfectants and not breakdown as a result of the bleach.

### BRIEF SUMMARY OF THE INVENTION

Briefly, the present invention provides a combination magnetic and dry erase board. The board comprises a magnetic retaining portion having a planar substrate having properties to attract and retain a magnet thereon and a bleach resistant covering disposed over the substrate. A dry erase portion comprises a porcelain surface. The dry erase portion is adjacent to the magnetic retaining portion.

Additionally, the present invention also provides a bleach resistant magnetic and dry erase board comprising a planar substrate having a first portion being a sheet covered portion and a second portion being a dry erasable portion. The second portion is adjacent to the first portion.

Further, the present invention provides a bleach resistant combination magnetic and dry erase board comprising a magnetic portion comprising a steel substrate and having a polymer covering and a dry erase portion adjacent to the magnetic portion. The dry erase portion comprises a steel substrate and has a porcelain coating thereon.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a perspective view of a mounting board according to a first exemplary embodiment of the present invention;

FIG. 2 is a front elevation view of the mounting board shown in FIG. 1;

FIG. 3 is a top plan view of the mounting board shown in FIG. 1, with the bottom plan view of the mounting board shown in FIG. 1 being the same;

FIG. 4 is a left side elevation view of the mounting board shown in FIG. 1, with the right side elevation view of the mounting board shown in FIG. 1 being the same;

FIG. 5 is a sectional view of the mounting board shown FIG. 2, taken along lines 5-5 of FIG. 2;

FIG. 5A is a sectional view of an alternative substrate configuration for the mounting board shown FIG. 2, taken along lines 5A-5A of FIG. 2;

FIG. 6 is a perspective view of a mounting board according to a second exemplary embodiment of the present invention;

FIG. 7 is a front elevation view of the mounting board shown in FIG. 6;

FIG. 8 is a top plan view of the mounting board, shown in FIG. 6, with the bottom plan view, the left side elevation view, and the right side elevation view of the mounting board shown in FIG. 6 being the same;

FIG. 9 is a perspective view of a mounting board according to a third exemplary embodiment of the present invention;

FIG. 10 is a front elevation view of the mounting board shown in FIG. 9;

FIG. 11 is a top plan view of the mounting board, shown in FIG. 9, with the bottom plan view, the left side elevation view, and the right side elevation view of the mounting board shown in FIG. 9 being the same;

FIG. 12 is a perspective view of a mounting board according to a fourth exemplary embodiment of the present invention;

FIG. 13 is a front elevation view of the mounting board shown in FIG. 12;

FIG. 14 is a top plan view of the mounting board shown in FIG. 12;

FIG. 15 is a bottom plan view of the mounting board shown FIG. 12;

FIG. 16 is a left side elevation view, with the right side elevation view of the mounting board shown in FIG. 6 being the same;

FIG. 17 is a perspective view of a mounting board according to a fifth exemplary embodiment of the present invention;

FIG. 18 is a front elevation view of the mounting board shown in FIG. 17; and

FIG. 19 is a top plan view of the mounting board, shown in FIG. 17, with the bottom plan view, the left side elevation view, and the right side elevation view of the mounting board shown in FIG. 17 being the same.

### DETAILED DESCRIPTION OF THE INVENTION

In the drawings, like numerals indicate like elements throughout. Certain terminology is used herein for convenience only and is not to be taken as a limitation on the present invention. The term “bleach resistant” refers to a material that can be cleaned with a household or commercial bleach containing product and not degrade. The term “magnetic retaining” refers to a material to which a magnet has a magnetic attraction. The term “sheet” refers to a material covering that can be woven or nonwoven. Additionally, a “sheet” may be a flexible material, such as a fabric, or a rigid material, such as a laminate. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

The present invention includes multiple embodiments of mounting boards that can be mounted on the wall and display information, such as papers removably attached thereto and message is written directly thereon. The inventive mounting boards are constructed of materials that are resistant to bleach-containing materials that may be used to clean the boards.

The inventive mounting board withstands the application of bleach cleaners that are used in locations, such as hospitals, in an effort to eliminate harmful bacteria, such as Clostridium difficile, along with other germs and viruses. An exemplary commercial bleach cleanser may be a solution having approximately 10% bleach by weight. An exemplary bleach may be sodium hypochlorite, calcium hypochlorite, chlorine, chlorine dioxide, hydrogen peroxide, sodium percarbonate, sodium perborate, or other bleach. A commercial cleaner may be Clorox® cleaner.

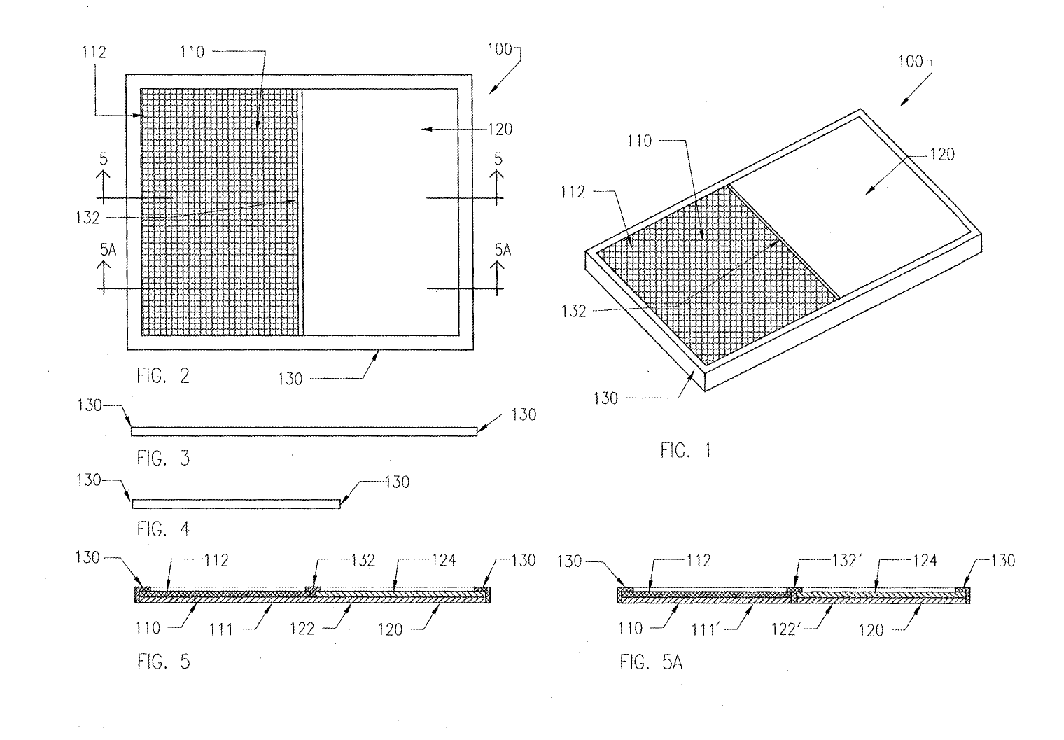

Referring to FIGS. 1-5, a first exemplary embodiment of a mounting board 100 according to the present invention is shown. Mounting board 100 includes a first, or magnetic retaining portion 110 and a second, or dry erase portion 120 that is adjacent to magnetic retaining portion 110. Magnetic retaining portion 110 may include a planar substrate 111 constructed from a metal, such as steel or other suitable material that has properties to attract and retain a magnet (not shown) thereon.

A bleach-resistant sheet or covering 112 is disposed over magnetic retaining portion 110 such that bleach-resistant covering 112 covers magnetic retaining portion 110. An adhesive may be used to adhere covering 112 to magnetic retaining portion 110.

In an exemplary embodiment, bleach-resistant covering 112 may be a polymer such as, for example, thermoplastics, such as polyurethane, polypropylene, polycarbonate, and acrylic, vinyl, polyethylene terephtalate glycol-modified (PETG), or other suitable bleach-resistant polymers. Bleach-resistant covering 112 may be a nonwoven sheet or, alternatively, bleach-resistant covering 112 may be a woven fabric sheet. Still alternatively, bleach-resistant covering 112 may be a plastic laminate sheet.

Dry erase portion 120 may be a planar substrate 122 constructed from a metal, such as steel or other suitable material. Optionally, planar substrate 122 may be a magnetic retaining portion such that magnets used in conjunction with magnetic retaining portion 110 may also be used in conjunction with dry erase portion 120. In an exemplary embodiment, the planar substrate 111 and magnetic retaining portion 110 and the planar substrate 122 in dry erase portion 120 may be the same substrate. Alternatively, as shown in FIG. 5A, planar substrate 111 and planar substrate 122 may be two separate substrates 111′ and 122′, with a spline 132′ separating substrates 111′ and 122′.

A porcelain surface 124 covers dry erase portion 120. Porcelain surface 124 may be baked onto substrate 122. Porcelain surface 124 allows the use of known dry erase markers (not shown) to write or draw on porcelain surface 124 and to be easily erased with a known dry erase eraser (not shown).

A frame 130 surrounds mounting board 100. As shown in FIG. 5, frame 130 has an “L-shaped” cross-section. Those skilled in the art, however, will realize that frame 130 may have other cross-sectional shapes, such as, for example, “C-shaped”.

A spline 132 extends between and separates magnetic retaining portion 110 and dry erase portion 120 from each other. Frame 130 and spline 132 may be constructed from a metal, such as aluminum, or a polymer, or other bleach resistant material. Frame 130 may be constructed from wood with a metal laminate.

Covering 112, porcelain surface 124, frame 130, and spline 132 are all constructed from bleach resistant materials that can be cleaned multiple times with a bleach containing cleanser without degradation.

Mounting board 100 may include hooks (not shown), or other known mounting devices on a rear surface thereof in order to mount mounting board 100 on a vertical surface, such as a wall.

Exemplary dimensions of mounting board 100 may be about 30 inches long, about 24 inches high and about ¾ inches deep. Frame 130 may be about 1¼ inches wide and spline 132 may be about 7/16 inches wide. Those skilled in the art, however, will recognize that mounting board 100 and its components may have other dimensions as well. Further, while mounting board 100 is rectangular in shape, those skilled in the art will recognize that a mounting board according to the present invention may have other shapes as well, including square, round, triangle, octagon, or any other suitable shapes, as are disclosed below.

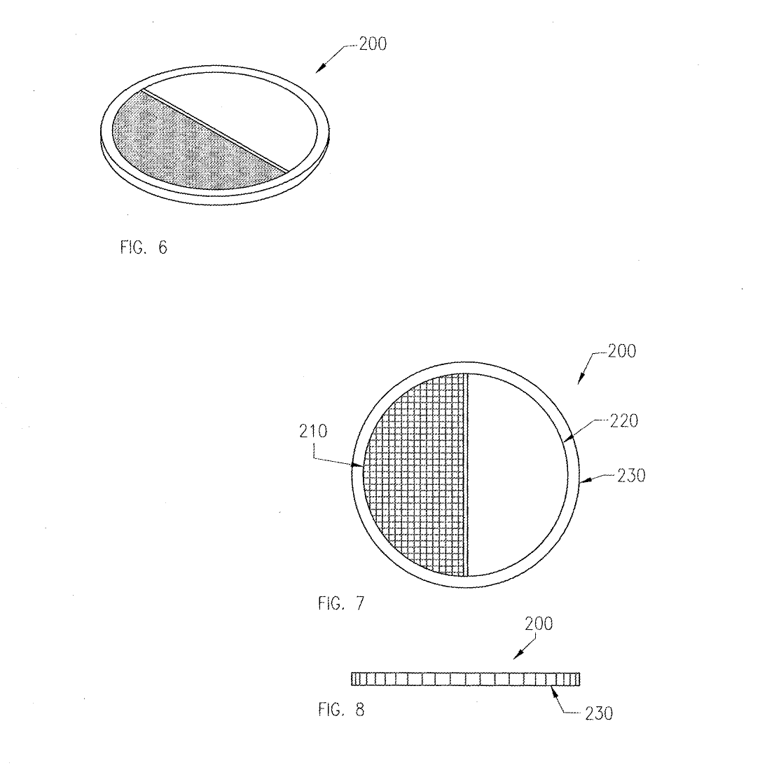

Referring to FIGS. 6-8, a mounting board 200 according to a second exemplary embodiment of the present invention is shown. Board 200 is similar to board 100 in that board 200 has a sheet covered magnetic retaining portion 210 and a dry erase portion 220 but has a round, instead of a rectangular, frame 230.

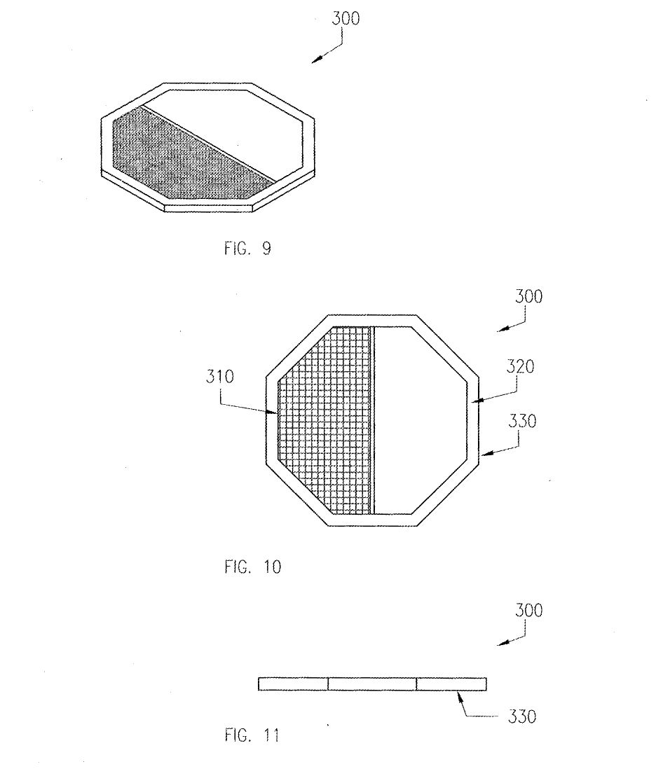

Referring to FIGS. 9-11, a mounting board 300 according to a third exemplary embodiment of the present invention is shown. Board 300 is similar to board 100 in that board 300 has a sheet covered magnetic retaining portion 310 and a dry erase portion 320 but has an octagonal, instead of a rectangular, frame 330.

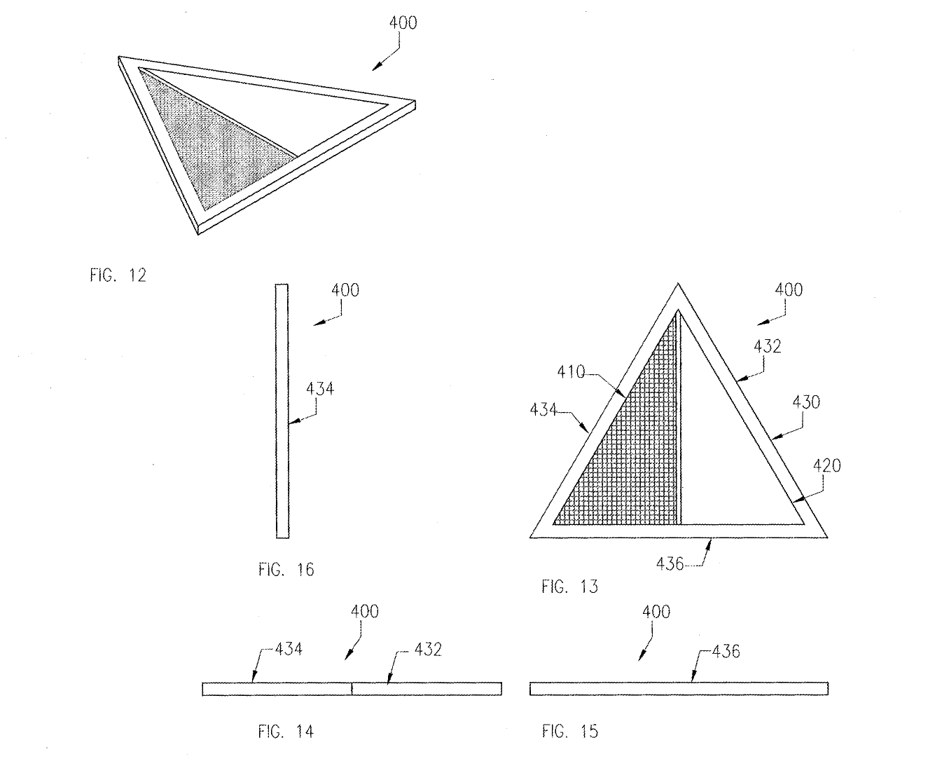

Referring to FIGS. 12-16, a mounting board 400 according to a fourth exemplary embodiment of the present invention is shown. Board 400 is similar to board 100 in that board 400 has a sheet covered magnetic retaining portion 410 and a dry erase portion 420 but has a triangular, instead of a rectangular, frame 430. Frame 430 includes side frames 432, 434 and a bottom frame 436.

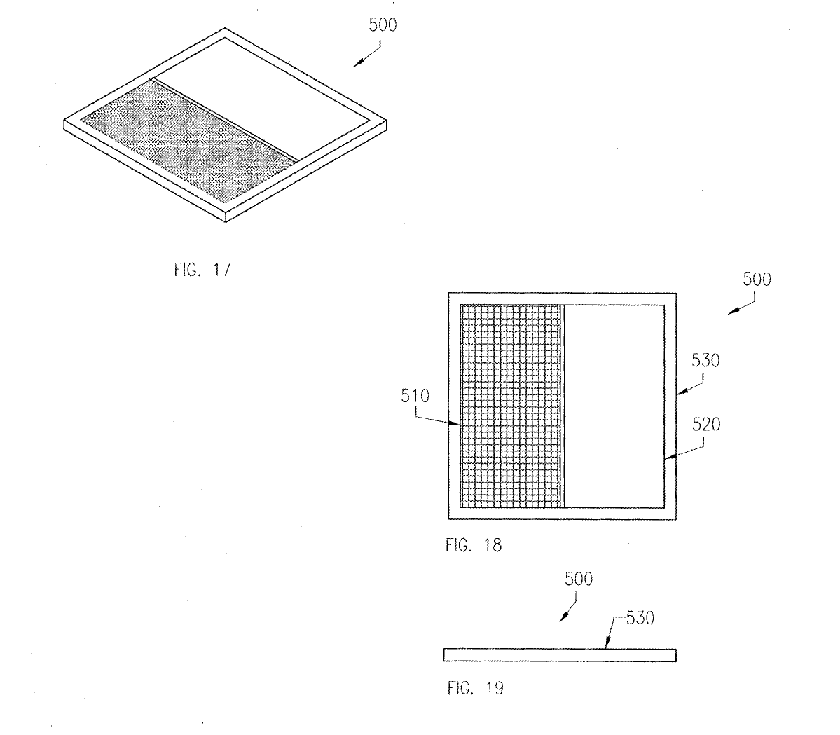

Referring to FIGS. 17-19, a mounting board 500 according to a fifth exemplary embodiment of the present invention is shown. Board 500 is similar to board 100 in that board 500 has a sheet covered magnetic retaining portion 510 and a dry erase portion 520 but has a square, instead of a rectangular, frame 330.

Additionally, while a mounting board having a combination of a magnetic retaining portion and a dry erase portion is contemplated, those skilled in the art will recognize that a mounting board according to the present invention may also include just a magnetic retaining portion or just a dry erase portion, and still retain the bleach resistant properties required for the contemplated use.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A combination magnetic and dry erase board comprising:
a magnetic retaining portion having:
a planar substrate having properties to attract and retain a magnet thereon; and
a bleach-resistant covering disposed over the substrate; and
a dry erase portion comprising a porcelain surface, the dry erase portion being adjacent to the magnetic retaining portion.

2. The board according to claim 1, further comprising a frame surrounding the magnetic retaining portion and the dry erase portion.

3. The board according to claim 2, further comprising a spline separating the magnetic retaining portion and the dry erase portion.

4. The board according to claim 3, wherein the frame and the spline are constructed from bleach-resistant materials.

5. The board according to claim 1, wherein the covering comprises polypropylene.

6. The board according to claim 1, wherein the covering comprises a woven sheet.

7. The board according to claim 1, wherein the covering comprises a non-woven sheet.

8. A bleach resistant magnetic and dry erase board comprising:
a planar substrate having:
a first portion being a sheet covered portion; and
a second portion being a dry erasable portion, the second portion being adjacent to the first portion.

9. The bleach resistant board according to claim 8, wherein the first portion further comprises a magnetic retaining portion disposed under the sheet.

10. The bleach resistant board according to claim 9, wherein the magnetic retaining portion comprises a steel substrate and wherein the second portion comprises a steel substrate.

11. The bleach resistant board according to claim 10, wherein the second portion comprises a porcelain covering over the steel substrate.

12. The bleach resistant board according to claim 8, further comprising a bleach resistant spline separating the first portion and the second portion.

13. The bleach resistant board according to claim 8, wherein the shape comprises a woven material.

14. The bleach resistant board according to claim 8, wherein the sheet comprises a non-woven material.

15. A bleach resistant combination magnetic and dry erase board comprising:
a magnetic portion comprising a steel substrate and having a polymer covering; and
a dry erase portion adjacent to the magnetic portion, the dry erase portion comprising a steel substrate and having a porcelain coating thereon.

16. The bleach resistant combination magnetic and dry erase board according to claim 15, wherein the steel substrate in the magnetic portion and the steel substrate in the dry erase portion comprise a single substrate.

17. The bleach resistant combination magnetic and dry erase board according to claim 15, further comprising a bleach resistant spline disposed between the magnetic portion and the dry erase portion.

18. The bleach resistant combination magnetic dry erase board according to claim 15, wherein the polymer cover comprises polypropylene.

19. The bleach resistant combination magnetic dry erase board according to claim 15, further comprising a bleach resistant frame disposed around the board.

20. The bleach resistant combination magnetic dry erase board according to claim 15, wherein the polymer cover comprises a woven sheet.
